(19) United States
(12) Patent Application Publication
(10) Pub. No.: US 2010/0104739 A1
(43) Pub. Date: Apr. 29, 2010

(54) SURFACE TREATING METHOD FOR PROBE CARD IN VACUUM DEPOSITION DEVICE

(76) Inventor: Wen-Yu Lu, Tainan County (TW)

Correspondence Address: OSTROLENK FABER GERB & SOFFEN, 1180 AVENUE OF THE AMERICAS, NEW YORK, NY, 100368403, US

(21) Appl. No.: 12/651,741

(22) Filed: Jan. 4, 2010

Related U.S. Application Data
(63) Continuation-in-part of application No. 11/311,179, filed on Dec. 20, 2005.

(51) Int. Cl. B05D 5/12; B05D 7/22

(52) U.S. Cl. 427/58; 427/238

(57) ABSTRACT

A treating method for a probe card in a vacuum deposition device, the probe card having a plurality of probes. The treating method includes: (a) preparing a shield body having a lower shield plate and an upper shield plate disposed above the lower shield plate and having a through hole; (b) placing the probe card into the shield body and between the lower and upper shield plates; (c) disposing the shielded probe card and the shield body into a vacuum deposition device such that at least a portion of each of the probes is exposed from the through hole, and that a circuit of the printed circuit board is shielded by the lower and upper shield plates; and (d) depositing at least one film on each of the probes through the through hole and within the vacuum deposition device.

### CROSS-REFERENCE TO RELATED APPLICATION

This application is a continuation-in-part (CIP) of U.S. patent application Ser. No. 11/311,179, filed on Dec. 20, 2005.

### BACKGROUND OF THE INVENTION

1. Field of the Invention

This invention relates to a surface treating method for a probe card.

2. Description of the Related Art

A probe card is used for testing whether a chip is faulty or not prior to packaging the chip in a semiconductor fabrication. According to various kinds of probes, probe cards can be classified into cantilever and vertical types, etc. A cantilever type probe card is described as follows.

As shown in FIG. 1, the cantilever type probe card 4 includes: a printed circuit board 42, a fixing plate 43 disposed on the printed circuit board 42, and a plurality of probes 41 made of an electrical conductive material and fixed to the fixing plate 43 for transmitting an electrical signal. Each of the probes 41 has a probe tip 412 for contacting with a testee (i.e., a test point of the chip), and a probe body 411 fixed to the fixing plate 43. The probe bodies 411 of the probes 41 are respectively and electrically connected to the printed circuit board 42 by bonding wires 44.

Because the probe tips 412 of the probes 41 are used to make contact with the chips (not shown), they are likely to wear with time to worsen the test reliability thereof.

Furthermore, dirt and residues from the chips are likely to stick on the probe tips 412, especially when the surfaces of the probe tips 412 are abraded and roughened. Therefore, in order to remove the dirt and residues and to smoothen the probe tips 412, it is necessary to polish the probe tips 412 by using a sandpaper after testing. However, the length of the probe tips 412 will be shortened gradually. As such, the probe card 4 should be replaced periodically and the cost for the semiconductor fabrication will be increased.

### SUMMARY OF THE INVENTION

Therefore, an object of the present invention is to provide a surface treating method for a probe card, which can prolong the lifetime of the probe card.

Accordingly, there is provided a treating method for a probe card including a printed circuit board, a fixing plate disposed on the printed circuit board, and a plurality of probes fixed to the fixing plate and connected electrically and respectively to a circuit of the printed circuit board, each of the probes having a probe body and a probe tip.

The treating method comprises:
(a) preparing a shield body having a lower shield plate and an upper shield plate disposed above the lower shield plate and having a through hole;
(b) placing the probe card into the shield body and between the lower and upper shield plates such that at least a portion of each of the probes is exposed from the through hole, and that the circuit of the printed circuit board is shielded by the lower and upper shield plates;
(c) disposing the shielded probe card and the shield body into a vacuum deposition device; and
(d) depositing at least one film on each of the probes through the through hole and within the vacuum deposition device.

Preferably, the film is one of a conductive film and an insulating film.

By the surface treating method of this invention, each of the probes of the probe card can be deposited with at least one of a conductive film and an insulating film. Furthermore, when the probes wear, the probes can be re-coated in situ with a conductive coating by shielding the circuit on the printed circuit board. Therefore, the probes need not be detached from the printed circuit board, and the lifetime of the probes (i.e., the lifetime of the probe card) can be prolonged.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a side view of a known probe card;

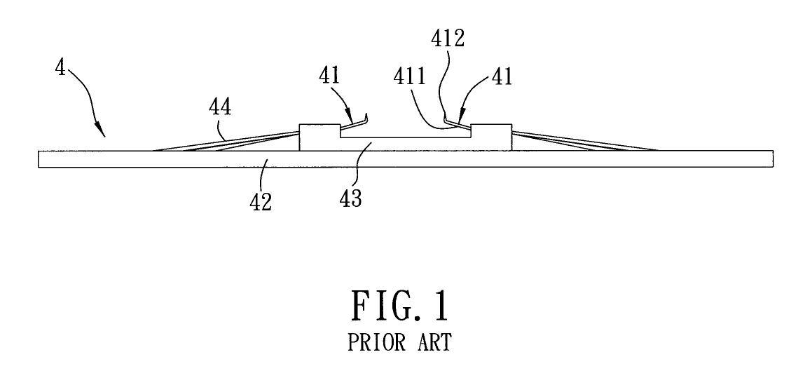

FIG. 2 is a perspective view of the probe card of FIG. 1;

FIG. 3 is an exploded perspective view of a shield body used in the surface treating method of the present invention to shield the probe card;

FIG. 4 is a cross-sectional view of the probe card shielded by the shield body in a vacuum deposition device;

FIG. 5 shows one of the probes on the probe card which is surface-coated through successive steps of the surface treating method according to the first embodiment of the present invention;

FIG. 6 is a flow chart showing the surface treating method according to the first embodiment of the present invention;

FIG. 7 is a cross-sectional view showing the shielded probe card and the shield body in a vacuum deposition device when an insulating film is deposited according to the second embodiment of the present invention;

FIG. 8 illustrates one of the probes on the probe card which is surface-coated through successive steps of the surface treating method according to the third embodiment of the present invention;

FIG. 9 is a cross-sectional view showing the shielded probe card and the shield body in a vacuum deposition device when a conductive film is deposited according to the third embodiment of the present invention; and

FIG. 10 is a cross-sectional view showing the probe card shielded by another shield body usable in the fourth embodiment of the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

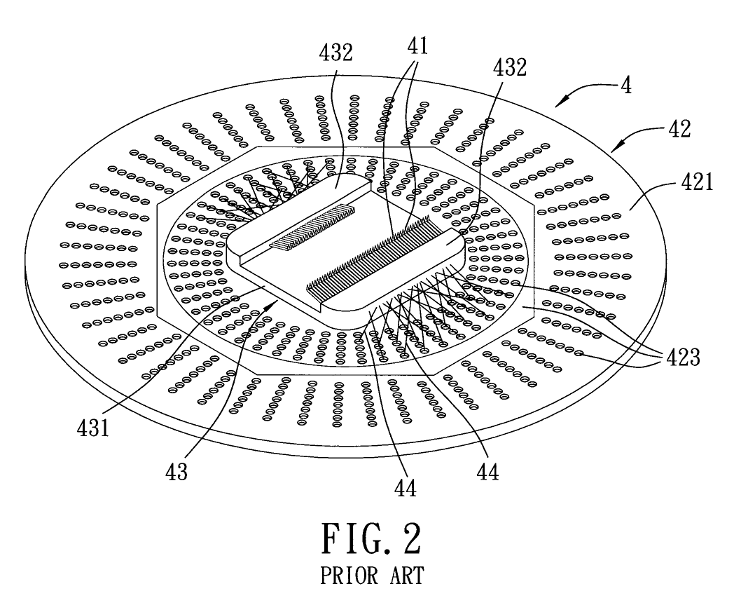

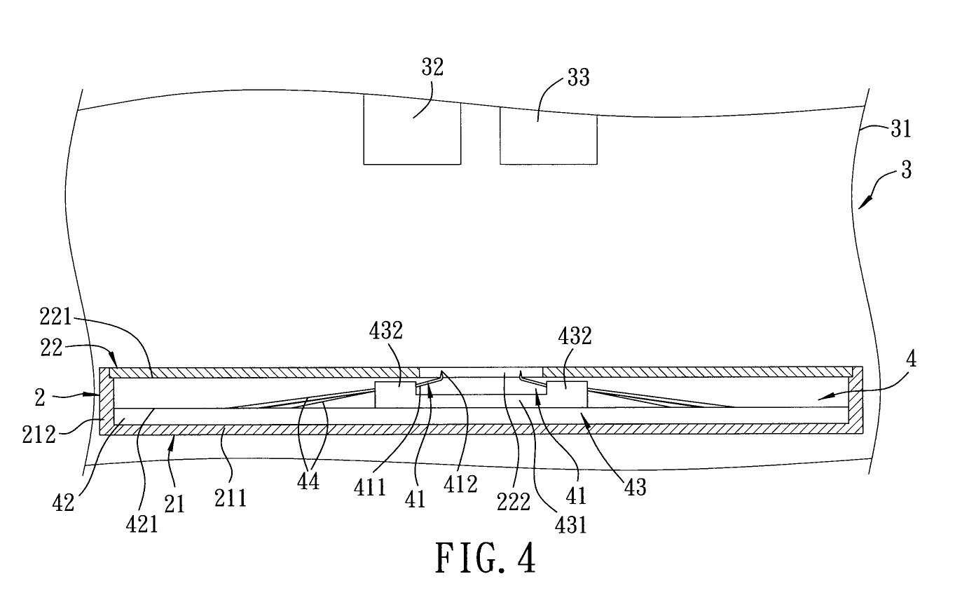

Referring to FIGS. 2 and 4, a probe card 4 that can be treated by the surface treating method according to the present invention is shown to include a plurality of probes 41, a printed circuit board 42, a fixing plate 43, and a plurality of bonding wires 44. The printed circuit board 42 has a circuit including a plurality of circuit elements 423 for transmitting electrical signals (only the circuit elements 423 on a top surface 421 of the printed circuit board 42 are shown). The circuit elements 423 include conductive pads, conductive wires, electronic components, etc. The fixing plate 43 is disposed on the printed circuit board 42, and has a base wall 431 and two side walls 432 respectively and upwardly extending from two parallel sides of the base wall 431. Two rows of the probes 41 are respectively fixed to the side walls 432. Each of the probes 41 has a probe body 411 and a probe tip 412. As shown in FIG. 4, in each probe 41, one end of the probe body 411 is fixed to one of the side walls 432, and the other end is bent and formed with the probe tip 412. The bonding wires 44 respectively extend through the fixing plate 43 to electrically connect the respective probes 41 to the respective circuit elements 423 arranged around the fixing plate 43.

The surface treating method of the present invention is conducted in a vacuum deposition device 3 (see FIG. 4). The vacuum deposition device 3 can be a vacuum sputtering device, or a vacuum vapor deposition device. In this embodiment, the vacuum deposition device 3 includes a vacuum chamber 31, and first and second target members 32, 33 respectively disposed in the vacuum chamber 31. The first target member 32 is for sputtering a conductive material, and the second target member 33 is for sputtering an insulating material.

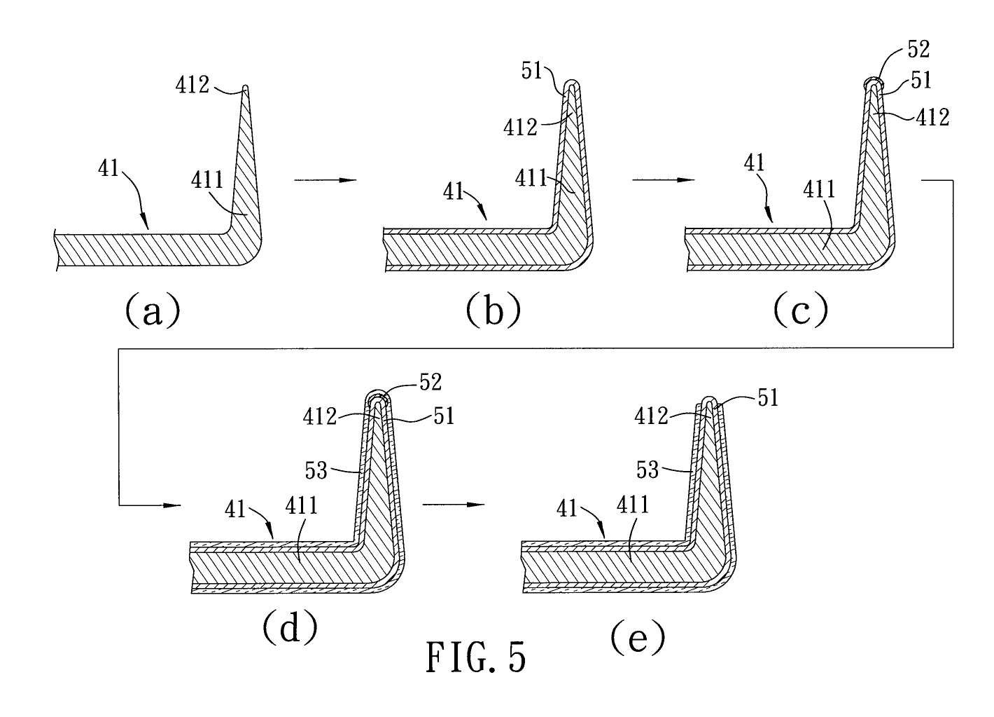

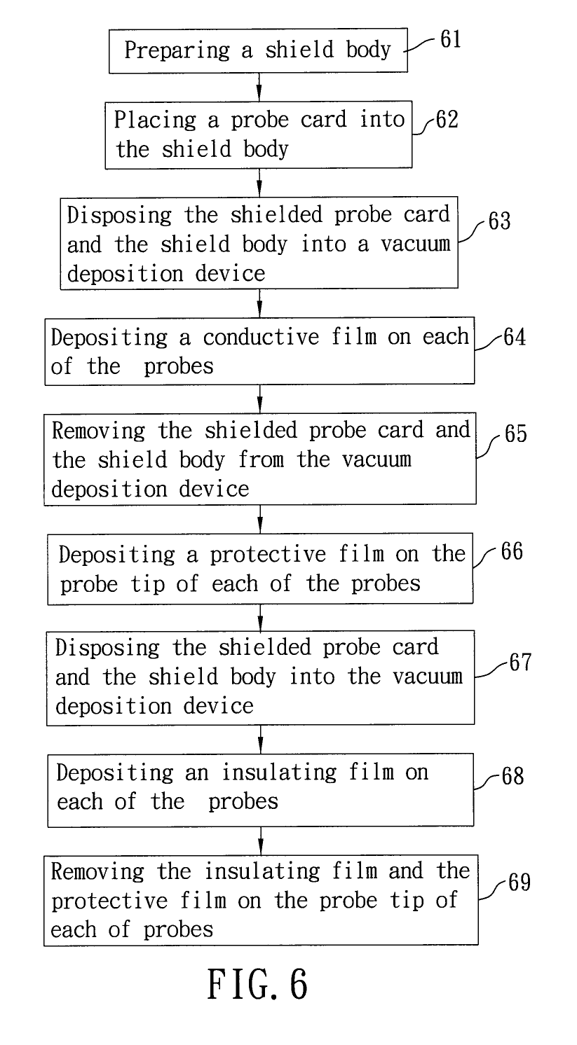

Referring to FIGS. 5 and 6, the surface treating method according to the first embodiment of the present invention is used to treat the probe card 4 as follows:

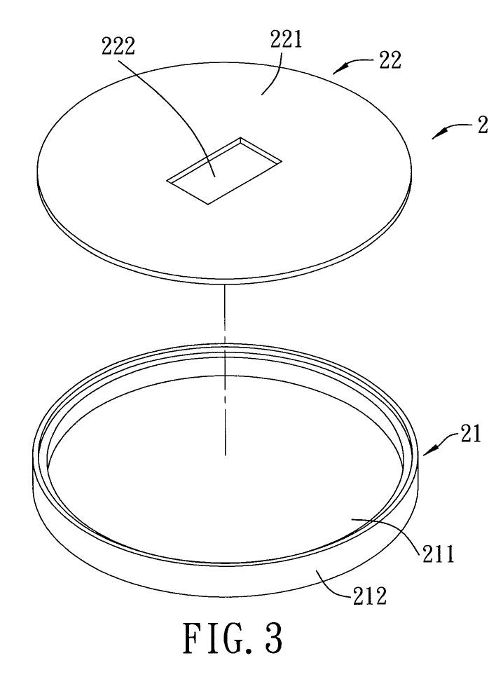

In step 61, a shield body 2 is prepared (see FIG. 3). The shield body 2 is for disposing the probe card 4 there inside during surface treating, and has a lower shield plate 21 and an upper shield plate 22 formed with a through hole 222. The lower shield plate 21 has a bottom wall 211 and a surrounding wall 212 upwardly extending from the bottom wall 211. The upper shield plate 22 has a shielding plate portion 221 surrounding the through hole 222 and covering detachably a top open end of the surrounding wall 212. The through hole 222 is formed in a central position of the second shield plate 22 to be aligned above the probes 41 of the probe card 4.

In step 62, the probe card 4 is placed into the shield body 2 by: disposing the probe card 4 on the bottom wall 211 of the lower shield plate 21; and covering the top open end of the surrounding wall 212 with the shielding plate portion 221 of the second shield plate 22.

By this step, the probe card 4 is disposed between the lower and upper shield plates 21, 22, the through hole 222 is aligned above all of the probes 43, and only the probe bodies 411 and the probe tips 412 of the probes 41 are exposed from the through hole 222. That is to say, each of the probes 41 is exposed entirely from the through hole 222, and all portions of the probe card 4 around the probes 41 including the side walls 432 of the fixing plate 43 and the bonding wires 44 are shielded.

In step 63, the shielded probe card 4 and the shield body 2 are disposed into the vacuum deposition device 3. As shown in FIG. 4, the probes 41 of the probe card 4 face toward the first and second target members 32, 33, and all portions of the probe card 4 around the probes 41 are shielded by the shield body 2 and are not treated by the first and second target members 32, 33.

In step 64, a conductive film 51 is deposited on each of the probes 41 including the probe body 411 and the probe tip 412 thereof (see FIG. 5 (b)) in the vacuum deposition device 3 using the first target member 32. The conductive film 51 is made of tungsten. Alternatively, the conductive film 51 may be made of tungsten alloy, or other metals or alloys as long as the metals or alloys have good electrical conductivity and high rigidity that can mitigate the abrasion of the probe tips 412.

Since all portions of the probe card 4 around the probes 41 are shielded by the shield body 2, they are not subjected to the deposition treatment in the step 64.

It should be noted that although, in the step 64, the conductive film 51 is formed on both of the probe body 411 and the probe tip 412 in each of the probes 41 (see FIG. 5(b)), only a part of the conductive film 51 formed on the probe tip 412 is essential. Whether or not the conductive film 51 is formed on the probe body 411 in each of the probes 41 is not important.

In step 65, the shielded probe card 4 and the shield body 2 are removed from the vacuum chamber 31 of the vacuum deposition device 3 after step 64.

In step 66, a protective film 52 is deposited on and covers the probe tip 412 of each of the probes 41 (see FIG. 5(c)). The probe card 4 is placed into the shield body 2 by the same manner as the step 62. The protective film 52 can be made of any insulating materials. In this embodiment, the protective film 52 is formed by brushing a photoresist agent on each of the probe tips 412 of the probes 41, followed by curing the photoresist agent.

In step 67, the shielded probe card 4 and the shield body 2 are disposed into the vacuum deposition device 3 again (see FIG. 4) by the same manner as the step 63.

In step 68, an insulating film 53 is deposited on the conductive film 51 on the probe body 411 and the protective film 52 on the probe tip 412 for each of the probes 41 (see FIG. 5 (d)) in the vacuum deposition device 3 using the second target member 33. In this embodiment, the insulating film 53 is made of silicon dioxide (SiO₂) . In other embodiments, the insulating film 53 can be made of any other insulating material.

Since all portions of the probe card 4 around the probes 41 are shielded by the shield body 2, they are not subjected to the deposition treatment in the step 68. After the step 68, the shielded probe card 4 and the shield body 2 are removed from the vacuum chamber 31.

In step 69, the insulating film 53 and the protective film 52 on the probe tip 412 of each of the probes 41 are removed. The insulating film 53 on the probe tip 412 of each of the probes 41 is removed by sanding with a sandpaper, and the protective film 52 thereon is removed by a suitable organic solvent to dissolve out the protective film 52. As shown in FIG. 5 (e), after the step 69, an outer surface of each probe body 411 is formed with the insulating film 53, and an outer surface of each probe tip 412 is formed with the conductive film 51.

By depositing the conductive film 51 on each probe tip 412, the probe card 4 that has worn probe tips 412 can be repaired for reuse in testing chips in semiconductor fabrication. Furthermore, the lifetime of the probe card 4 can be prolonged and the efficiency of the probes 41 for signal transmission can be improved since the conductive film 51 has good conductivity and rigidity.

By depositing the insulating film 53 on each probe body 411, electromagnetic interference among the probes 41 and short circuiting due to conductive particles falling between the probes 41 can be prevented.

Of course, the surface treating method of the present invention can be conducted for an unused probe card 4 to prolong the lifetime of the probe card 4 and to increase the signal transmitting efficiency of the probes 41.

Moreover, it is unnecessary to remove the probes 41 from the probe card 4 during surface treating of the probe card 4 according to the present invention, and thus, the method is very helpful and useful for repairing the probe card 4 that has worn probe tips 412.

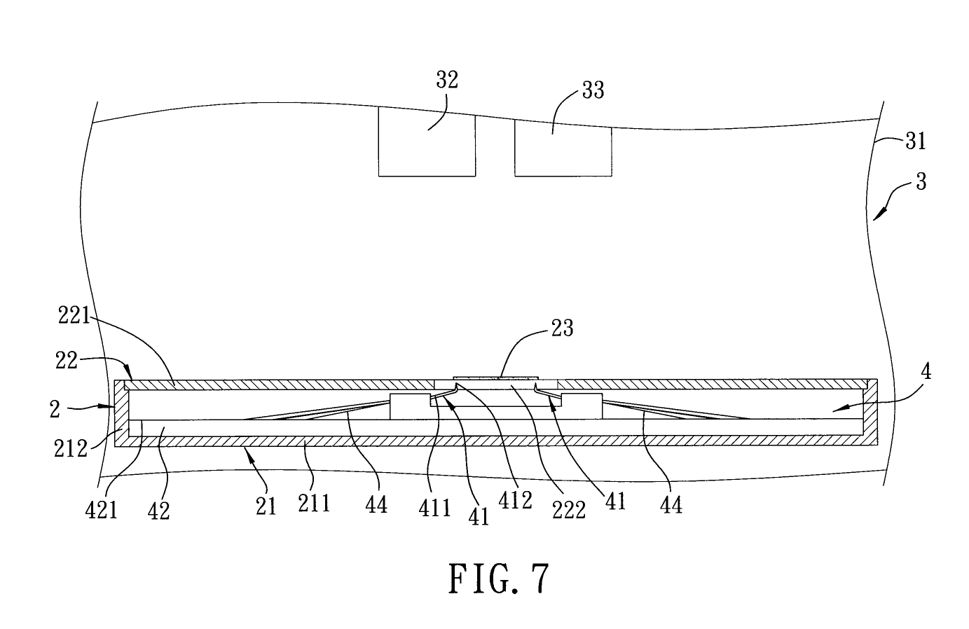

Referring to FIG. 7, according to the second preferred embodiment of the present invention, the through hole 222 of the upper shield plate 22 is covered partially by disposing a removable mask 23, such as a tape, across the through hole 222 (see FIG. 7). The removable mask 23 is aligned above the probe tips 412 of all of the probes 41, and is fixed removably to the upper shield plate 22. As such, only the probe bodies 411 of all of the probes 41 are exposed from the through hole 222, and the probe tips 412 of all of the probes 41 are shielded by the removable mask 23. Therefore, according to the second embodiment, the insulating film (not shown) is deposited only on the probe bodies 411 of the probes 41 after the conductive film 51 is deposited on the probe tip 412 and the probe body 411 of each probe 41 according to step of the first embodiment. The second embodiment dispenses with the step 66 of forming the protective film 52 and the step 69 of removing the protective film 52 and part of the insulating film 53 which are carried out in the first embodiment.

It should be noted that the shielding of the probe tips 412 of the probes 41 can be conducted by any possible method and should not limited to the embodiments of the present invention.

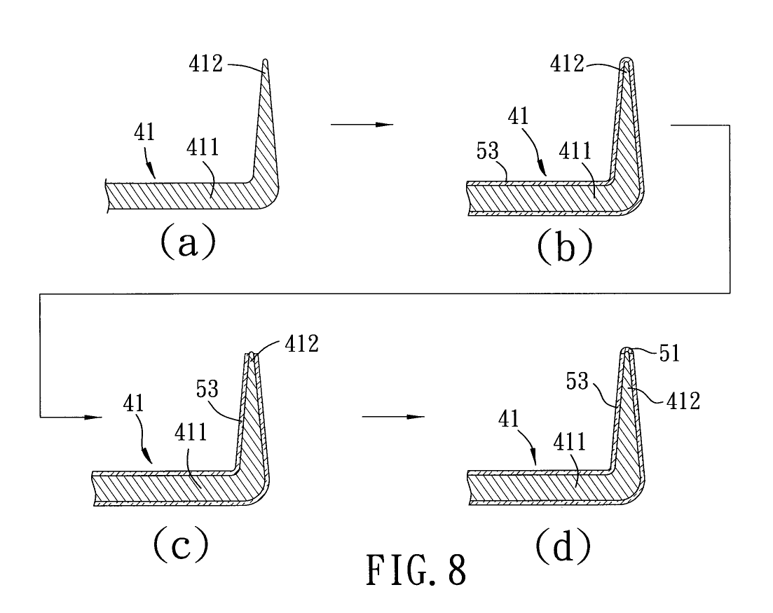

FIG. 8 illustrates the treating method for the probe card 4 according to the third embodiment of the present invention. The third embodiment differs from the first embodiment in that the insulating film 53 is formed before the conductive film 51 for each of the probes 41.

Of course, the probe card 4 is treated after being shielded by the shield body 2. When the insulating film 53 is deposited in the vacuum deposition device 3 as shown in FIG. 4, each of the probes 43 including the probe body 411 and the probe tip 412 thereof is covered with the insulating film 53 (see FIG. 8(b)). Then, the probe card 4 is removed from the vacuum chamber 31. Thereafter, as shown in FIG. 8(c), a portion of the insulating film 53 on the probe tip 412 of each of the probes 41 is removed using a sandpaper (not shown).

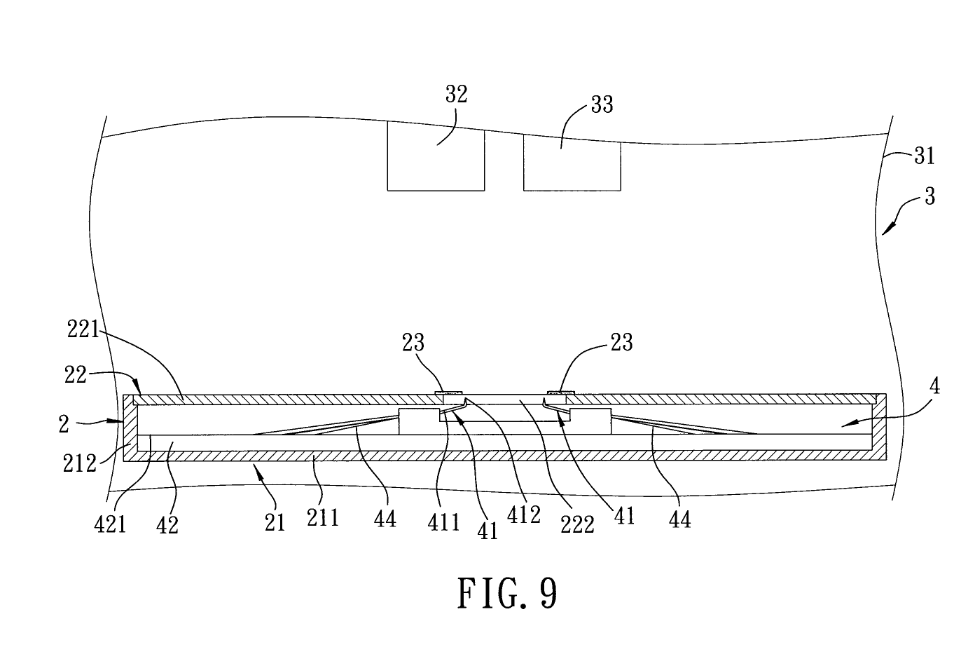

Before the deposition of the conductive film 51 in the vacuum deposition device 3, two removable masks 23 are disposed across the through hole 222 of the upper shield plate 22 to partially cover the through hole 222. Accordingly, as shown in FIG. 9, the probe bodies 411 of the probes 41 are shielded, and the probe tips 411 of the probes 41 are exposed from the through hole 222. Therefore, as shown in FIG. 8(d), the conductive film 51 is deposited only on the probe tip 412 of each of the probes 41.

As an alternative, the through hole 222 of the shield body 2 may be sized such that it exposes only the probe tips 412 of the probes 41 so as to deposit the conductive film 51 only on the probe tips 412.

It should be noted that, according to the surface treating method of the present invention, it is possible to form only one of the conductive film 51 and the insulating film 53 on the probes 41.

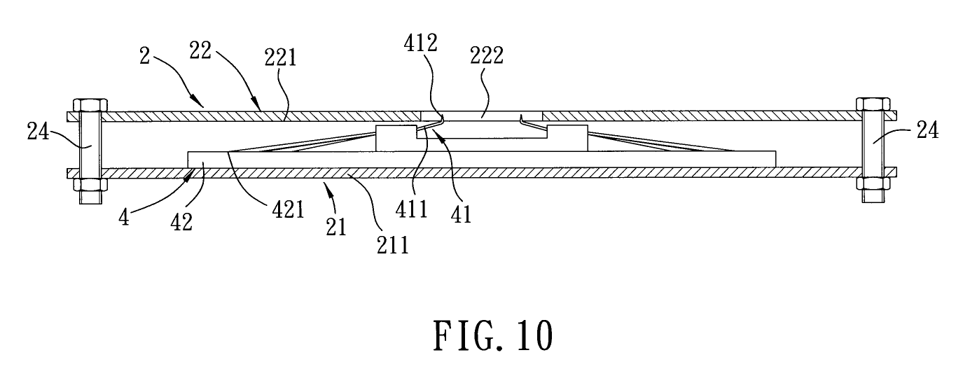

FIG. 10 illustrates another shield body 2 used in the surface treating method for shielding the probe card 4 according to the fourth embodiment. The fourth embodiment differs from the first embodiment only in the structure of the shield body 2.

In this embodiment, the upper shield plate 22 is spaced above the lower shield plate 21 that is not provided with the surrounding wall 212, and the shield body 2 further has a coupling unit having two coupling screws 24 extending threadedly through the lower and upper shield plates 21, 22.

Therefore, in order to place the probe card 4 into the shield body 2, firstly, a gap between the lower and upper shield plates 21, 22 is adjusted by operating or rotating the coupling screws 24. Thereafter, the probe card 4 is placed between the lower and upper shield plates 21, 22 such that the through hole 222 is aligned above all of the probes 41.

If necessary, the gap between the lower and upper shield plates 21, 22 can be adjusted such that the probe tips 412 of the probes 41 extend into the through hole 222.

For better shielding of all portions of the probe card 4 around the probes 41, it is practicable to provide an aluminum foil between the lower and upper shield plates 21, 22 to cover four sides of the gap.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A treating method for a probe card in a vacuum deposition device, the probe card including a printed circuit board, a fixing plate disposed on the printed circuit board, and a plurality of probes fixed to the fixing plate and connected electrically and respectively to a circuit of the printed circuit board, each of the probes having a probe body and a probe tip, the treating method comprising:
(a) preparing a shield body having a lower shield plate and an upper shield plate disposed above the lower shield plate and having a through hole;
(b) placing the probe card into the shield body and between the lower and upper shield plates such that at least a portion of each of the probes is exposed from the through hole, and that the circuit of the printed circuit board is shielded by the lower and upper shield plates;
(c) disposing the shielded probe card and the shield body into the vacuum deposition device; and
(d) depositing at least one film on each of the probes through the through hole and within the vacuum deposition device.

2. The treating method of claim 1, wherein the through hole is aligned above all of the probes, and the upper shield plate further has a shielding plate portion surrounding the through hole and shielding all portions of the probe card around the probes.

3. The treating method of claim 1, wherein the lower shield plate has a bottom wall and a surrounding wall upwardly extending from the bottom wall, and wherein the step (b) includes the following sub-steps:
disposing the probe card on the bottom wall of the lower shield plate; and
covering a top open end of the surrounding wall with the upper shield plate such that the through hole is aligned above all of the probes.

4. The treating method of claim 1, wherein the upper shield plate is spaced above the lower shield plate, the shield body further having a coupling unit extending threadedly through the lower and upper shield plates; and wherein the step (b) includes the following sub-steps:
adjusting a gap between the lower and upper shield plates by operating the coupling unit; and
placing the probe card between the lower and upper shield plates such that the through hole is aligned above all of the probes.

5. The treating method of claim 1, wherein the step (d) includes the following sub-steps:
(e) depositing a conductive film on each of the probes including the probe tip and the probe body thereof;
(f) depositing a protective film on each of the probe tips which has a portion of the conductive film deposited thereon, thereby covering the portion of the conductive film;
(g) depositing an insulating film on each of the probes which has the conductive film and the protective film deposited thereon, thereby covering the conductive film and the protective film; and
(h) removing the protective film and the portion of the insulating film deposited on each of the probe tips, thereby exposing a portion of the conductive film deposited on each of the probe tips.

6. The treating method of claim 1, wherein each of the probes is exposed entirely from the through hole.

7. The treating method of claim 1, wherein one of the probe tip and the probe body of each of the probes is exposed from the through hole.

8. The treating method of claim 7, wherein the through hole is covered partially so that one of the probe tip and the probe body of each of the probes is exposed from the through hole and the other one of the probe tip and the probe body of each of the probes is unexposed from the through hole.

9. The treating method of claim 8, wherein the through hole is covered partially by disposing a removable mask across the through hole, the removable mask shielding only one of the probe body and the probe tip of each of the probes.

10. The treating method of claim 7, wherein, in step (d), the film is deposited on one of the probe body and the probe tip of each of the probes.

11. The treating method of claim 10, wherein the film is a conductive film deposited on the probe tip of each of the probes.

12. The treating method of claim 10, wherein the film is an insulating film deposited on the probe body of each of the probes.

13. The treating method of claim 1, wherein the step (d) includes the following sub-steps:
(e) depositing an insulating film on each of the probes including the probe tip and the probe body thereof;
(f) removing a portion of the insulating film on the probe tip of each of the probes;
(g) partially covering the through hole to expose the probe tip of each of the probes and to unexpose the probe body of each of the probes; and
(h) depositing a conductive film on the probe tip of each of the probes exposed from the through hole.
